(19) United States
(12) Patent Application Publication
(10) Pub. No.: US 2004/0221058 A1
(43) Pub. Date: Nov. 4, 2004

(54) Nested protection switching in a mesh connected communications network

(75) Inventors: Evert E. de Boer, Nepean (CA); Jeanpierre Coupal, Gatineau (CA); Richard Trudel, Ile Bizard (CA); Guy Boutin, Repentigny (CA); Mohamed El-Torky, Pointe Claire (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 10/364,622

(22) Filed: Feb. 12, 2003

(51) Int. Cl. G06F 15/173

(52) U.S. Cl. 709/238

(57) ABSTRACT

In a mesh connected communications network, nested link protection for a working link between two nodes across the network is provided. In the event of a fault on the working link between the two nodes, traffic on the link may be switched to a single parallel link between the two nodes, thereby restoring traffic on the link. Additionally, a link protection path extending between the two nodes is provisioned by way of at least one intermediate node. In the event the parallel protection link is not available, traffic carried on the working link may be switched to the link protection path, restoring traffic to the second node by way of the intermediate node. Conveniently, link protection path switching may be used in the event the parallel protection link is not available or at the choice of an operator.

### FIELD OF THE INVENTION

The present invention relates generally to communications mesh connected networks, and more particularly to communications networks that allow protection switching in the event of a fault along a link on the network.

### BACKGROUND OF THE INVENTION

The need to provide reliable communications between nodes on communications networks has been appreciated for some time. As such, in the event of faults, modern network designs often provide for protection of links between adjacent nodes or across entire connections between end-point nodes which cross multiple links across such networks.

For example, synchronous optical networks (“SONET”) and asynchronous transfer mode (“ATM”) networks include protection switching providing 1+1, 1:1, 1:n, or m:n redundancy. In the event of a fault, exemplified by failed or degraded signal, traffic from a working link may be switched to a provisioned protection link, thereby limiting the effects of a fault.

Typically, however, protection switching is provided for either a connection between two end-points on the network, or for individual links between adjacent network elements. Historically, for example, link protection switching in SONET networks was effected linearly, between adjacent nodes using conventional 1+1, 1:1, 1:n linear protection switching between such nodes. Path protection switching was also available in some SONET networks using uni-directional path switched rings (UPSR). Two paths of interconnected links between communicating end nodes were established: one connecting the end nodes in a clockwise direction; the other in a counter clockwise direction. In the event of a fault along one path, the other was used in favour of the faulted path. For such rings only 1:1 path protection switching was available—1:n and m:n protection switching was not.

Recently, protection switching has been proposed for meshed networks, in which multiple connections between source and destination nodes are typically possible. In such networks, independent working and protection connections between end points may be allocated, and in the presence of a fault of a working channel, traffic may be switched and carried on the protection channel. Such protection switching, however, takes time as a fault along the connection must typically be signalled to the source node. Depending of the location of the fault, such signalling may require signalling along almost the entire connection.

Additionally, switching traffic to a protection channel requires allocation of an entire redundant channel between end points to compensate for a failure at a single node or between two nodes.

Moreover, in the presence of a failure on an entire link (as is often the case), as the result of for example, a cut or deteriorated physical cable, multiple working channels need to be individually switched.

Accordingly, there is a need for new network protocols, methods and devices that provide improved protection switching across a mesh connected network.

### SUMMARY OF THE INVENTION

In accordance with the present invention, nested link protection for a working link between two adjacent nodes across a meshed network is provided. In the event of a fault on the link between the two nodes, traffic on the link may be switched to a single parallel link between the two nodes, thereby restoring traffic on the link. Additionally, a link protection path extending between the two nodes is provided by way of a third, intermediate node. In the event the parallel protection link is not available, traffic carried on the working link may be switched to the link protection path, restoring traffic carried on the working link by way of the link protection path. Conveniently, link protection path switching may be used, in the event the parallel protection link is not available or at the choice of an operator. Two levels of nested protection switching between the two adjacent nodes are thus provided.

In accordance with one aspect of the invention there is provided in a communications network, including a plurality of interconnected network nodes and a working link extending between first and second adjacent ones of the network nodes, a method of signalling a fault on the working link. This method includes determining if the working link is to be protected by way of a single protection link between the first and second nodes, or by way of a link protection path extending from the first node to the second node by way of an intermediate node. In dependence on this determining, this method further includes signalling the first node to initiate switching of traffic from the working link to the single protection link or to the link protection path.

In accordance with another aspect of the invention there is provided a communications network that includes: a plurality of communications nodes communicatively interconnected by links, each of the links connecting two adjacent nodes; a working link extending between first and second nodes and provisioned to carry traffic; a protection link extending alongside the working link, and provisioned to carry the traffic in the event of a fault along the working link; a link protection path extending between the first and second nodes and through at least one intermediate node and including a plurality of cross-connected protection links; and at least one signalling channel to signal a fault on the working link to the first node, thereby allowing the first node to switch the traffic on the working link to the protection link or the link protection path. The link protection path is provisioned to carry traffic between the first and second nodes in the event of a fault along the working link.

In accordance with another aspect of the invention there is provided a node in a communications network including: a switch fabric for cross-connecting input links to output channels; and a processor in communication with the switch fabric. The processor is operable to: establish cross-connects in the switch fabric; detect a fault on a working link switched by the switch fabric; determine a mode of signalling of the fault; and signal the fault to an immediately upstream node. This signalling effects protection switching of traffic on the working link to one of a protection link connecting the node to the immediately upstream node, or a link protection path connecting the node to the immediately upstream node by way of an intermediate node.

In accordance with another aspect of the invention, there is provided in a communications network, including a plurality of network nodes interconnected in a mesh, a method of providing nested protection switching for a working link between an adjacent first and second communications node on the network. This method includes: provisioning a protection link, extending between the first and second nodes; provisioning a link protection path, extending from the first node to the second node by way of an intermediate node; switching traffic carried on the working link to the protection link or the link protection path, in dependence on receiving an indicator of a fault on the working link.

In accordance with another aspect of the invention, there is provided a node in a communications network including: means for establishing cross-connects between links at the node; means for detecting a fault on a working link connected to the means for establishing cross-connects; means for signalling the fault to an immediately upstream node, to effect protection switching of traffic on the working link to a protection link connecting the node to the immediately upstream node; and means for signalling the fault to the immediately upstream node, to effect protection switching of traffic on the working link to the link protection path connecting the node to the immediately upstream node by way of an intermediate node.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a simplified schematic diagram of a communications network;

FIG. 2 is a simplified schematic diagram of network node in the network of FIG. 1;

FIG. 3 is a simplified schematic diagram of a portion of the network of FIG. 1, illustrating provisioned communications links;

FIGS. 4A-4F are simplified schematic diagrams of a portion of the network of FIG. 1, illustrating operation of the network;

FIG. 5 is a flowchart illustrating steps exemplary of the present invention, performed at a node in the portion of the network of FIGS. 4A-4F; and

FIG. 6 illustrates the format of data transported on an exemplary network.

### DETAILED DESCRIPTION

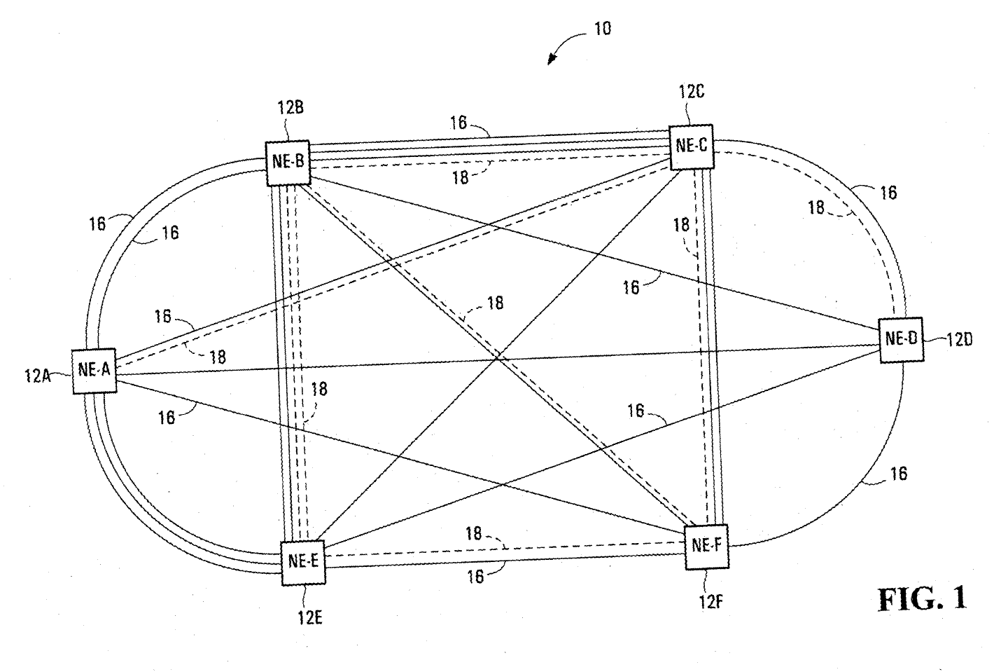

FIG. 1 illustrates an exemplary communications network 10 including a plurality of communication network nodes 12a-12f (individually and collectively referred to as nodes 12, individually referred to as nodes A, B, C, . . . F). Each of nodes 12 is physically interconnected to one or more of the remaining nodes 12, by physical links 16 and 18, for the transport of traffic.

Links 16 and 18 may, for example, be fibre-optic cables or the like. Links between adjacent nodes are illustrated. Links 16 and 18 allow bi-directional communication between adjacent nodes. As will become apparent, each link 16, 18 may transport one or many traffic carrying channels between two adjacent nodes.

Links 16 are configured to carry traffic between nodes during normal operating conditions. Links 18, on the other hand, are configured as protection links, useable to carry traffic otherwise transported on links 16 in the presence of a fault on a link 16. A variety of working and protection links are illustrated as extending between various adjacent nodes. For example, one working link 16 and one protection link 18 are illustrated between nodes B and F; three working links and one protection link 18 are illustrated between nodes B and C; etc.

For clarity of identification, links between adjacent nodes will, hereinafter be identified by the nodes they connect. For example, a protection link 18 between nodes B and C will hereinafter be identified as protection link B-C.

Network 10 is exemplary of a mesh connected network: nodes 12 are interconnected to multiple neighbouring nodes 12. In the illustrated example embodiment, network 10 is a closed mesh: each node 12 is interconnected with each other node 12 by at least one working link 16. Network 10 could, of course, not be a closed mesh. Some nodes 12 could only be interconnected with a subset of the remaining nodes 12 on network 10. Although example network 10 is illustrated to include only six nodes 12, network 10 could easily be scaled to include an arbitrary number of interconnected nodes 12. Network 10 may be a single network, or may be a collection of interconnected sub-networks.

Each node 12 is a conventional communications node. As will become apparent each node 12 may be a SONET cross-connect or add drop multiplexer. Each node 12 could alternatively be an optical cross-connect, a network router, an ATM switch, or another suitable communications node appreciated by a person of ordinary skill.

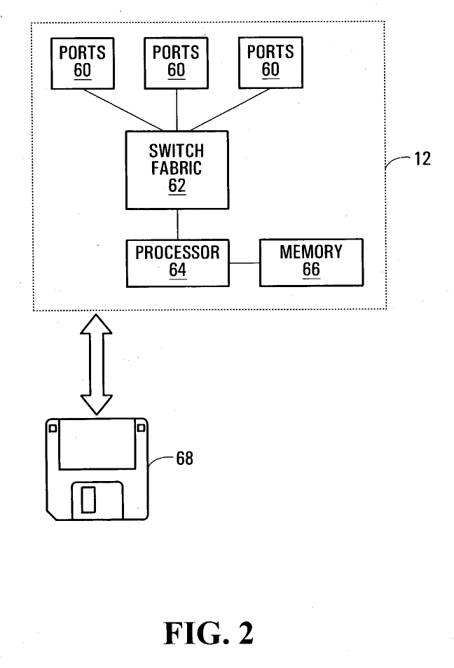

A simplified example architecture of nodes 12 is illustrated in FIG. 2. As illustrated, each node 12 preferably includes a plurality of ports 60 for interconnecting links 16 and 18; a switch fabric 62 for cross-connecting the links, or channels thereon; one or more processors 64; and memory 66 storing software adapting the node 12 to transport and cross-connect traffic and to function in manners exemplary of an embodiment of the present invention. Suitable software may be loaded from a conventional computer readable medium 68, which may be a diskette, CD ROM, or the like.

As noted, working links 16 may transport one or more traffic bearing channels between adjacent nodes 12. A connection allows communication between source and destination nodes 12 at the end of the connection across multiple links 16 across the network 10. To establish a connection, an interconnection at each node 12 along the connection cross-connects an input from an upstream node 12 to an immediately adjacent downstream node 12 along the connection. That is, at each node 12 along an established path, at least one channel on a link 16 from an upstream node 12 interconnects to one or more channels on a link 16 to a downstream node 12. The end-to-end connection is thus defined by cross-connected channels across links 16 between source and destination nodes 12. In a mesh connected network, such as network 10, multiple different connections may connect any two network nodes 12.

Nodes 12 can be configured in any number of ways to allow for the establishment of such end-to-end connections. Each node 12 may, for example, be associated with a connection controller that is under software control and allows the establishment of cross-connections at nodes 12 and thereby end-to-end connections between pairs of nodes 12, using a path establishment protocol, as for example G.MPLS. Alternatively, connections may be established using an operations, administration, maintenance, and provisioning (OAM&P) system that allows centralized manual configuration of connections at each node 12 along an end-to-end connection.

Network nodes 12 further support other network protocols for the transport of data across network 10 by way of links 16. Network 10 may be embodied using network nodes 12 that adhere to any one of a number of suitable protocols including for example, synchronous digital hierarchy (SDH) protocols, asynchronous transfer mode (ATM) protocols, wavelength division multiplexing (WDM) protocols, or the like.

Exemplary of an embodiment of the present invention, protection links 18 also extend between some or all adjacent nodes 12 of network 10. For example, as illustrated in FIG. 1, example protection links 18 shown include those extending between nodes B and C; nodes B and E; and nodes C and D. Other protection links may similarly extend between adjacent nodes 12.

As noted, protection links 18 are physically similar to working links 16, but are typically provisioned to carry traffic otherwise carried by working links 16 in the presence of a fault on a working link 16. As such, a protection link 18 between nodes 12 is capable of carrying traffic on all channels otherwise carried on a working link 16 between those two nodes 12. Protection links 18 may provide 1+1; 1:n or m:n link protection between adjacent nodes 12. Such protection links 18 are for example known in SONET networks, and further detailed in ITU Recommendations G.783.

In the same way as multiple connections may be established across mesh connected network 10, and exemplary of an embodiment of the present invention, it is also possible to provide for the protection of working links 16 in multiple ways. For example, a single protection link B-C between nodes B and C may protect a working link B-C. Alternatively a collection of several protection links B-E; E-F; F-C could be combined to form a link protection path. Other equivalent combinations of protection links 18 could similarly be combined to form link protection paths, protecting working link B-C. For example, the collection of protection links B-D; D-C; or B-A; A-C could similarly be combined to provide a link protection path between nodes B and C.

Exemplary of embodiments of the present invention, protection links 18 are combined to provide an additional link protection path between two adjacent nodes 12. In effect, network 10 thus provides multiple levels of link protection switching: a single protection link 18 between two immediately adjacent nodes 12, and one or more alternate link protection paths made up of several protection links 18 connecting the protected nodes 12, by way of one or more additional nodes 12.

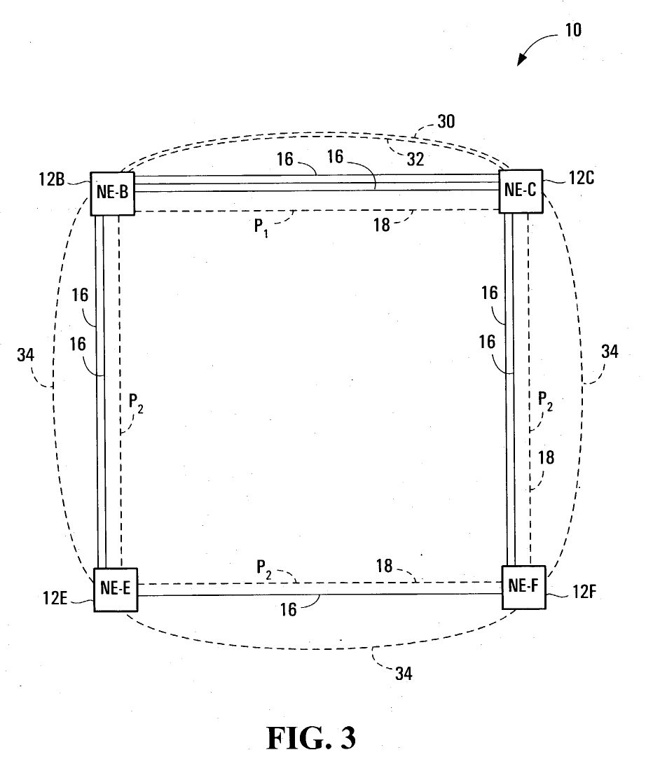

For illustration, a single protection link B-C for a working link between nodes B and C, and a link protection path for link B-C are illustrated in FIG. 3. For clarity, nodes A and D, and links 16 and 18 not required for illustration have been omitted from FIG. 3. As illustrated, a protection link B-C (labelled P1) provides 1:n link protection switching for a working link 16 extending between first and second nodes B and C. Of course, 1+1 or m:n link protection between nodes B and C could be similarly provisioned.

Additionally, a provisioned link protection path (labelled P2) formed through the cross-connection of multiple protection links 18 is also illustrated. As illustrated, a link protection path P2 formed from protection links B-E; E-F and F-C is illustrated. It thus extends through intermediate third and fourth nodes E and F. Link protection path P2 may be provisioned by a network administrator by configuring nodes E and F to cross-connect protection links B-E, E-F; and F-C. A mapping of link protection path P2 to protected working link 16 is also preferably stored within memory at the head and tail end of a protected working link 16.

In order to facilitate protection switching, multiple independent signalling channels are also preferably provided. Preferably, for each protection link 18, an associated signalling channel is provisioned to allow signalling of a fault along a protected working link 16 to the head end of the link 16. As such, a link protection signalling channel 32 is established between nodes B and C, as illustrated in FIG. 3.

An additional link protection path signalling channel 30 is also schematically illustrated in FIG. 3. For clarity, nodes A and D and unused links of network 10 are not illustrated. Signalling channel 32 may signal the head end of the link between node B and node C to effect protection switching from the working link 16 to an available single protection link 18. Path signalling channel 30 allows signalling from nodes 12 to effect link protection path switching.

Additionally, a further signalling channel 34 extending from head node B to tail node C, by way of intermediate nodes E and F is illustrated.

Now, exemplary of embodiments of the present invention, in the presence of a fault between adjacent nodes 12, a node 12 detecting the fault dispatches, or attempts to dispatch, a signal along the signalling channel 32 used for signalling protection switching for the working link 16 to an immediately upstream node 12. If an available single protection link 18 exists and is available between the adjacent nodes 12 connected by the working link 16, the working link 16 may be switched to the single protection link 18. Traffic along the link, and thus along multiple connections using the link from multiple sources to multiple destinations, is restored.

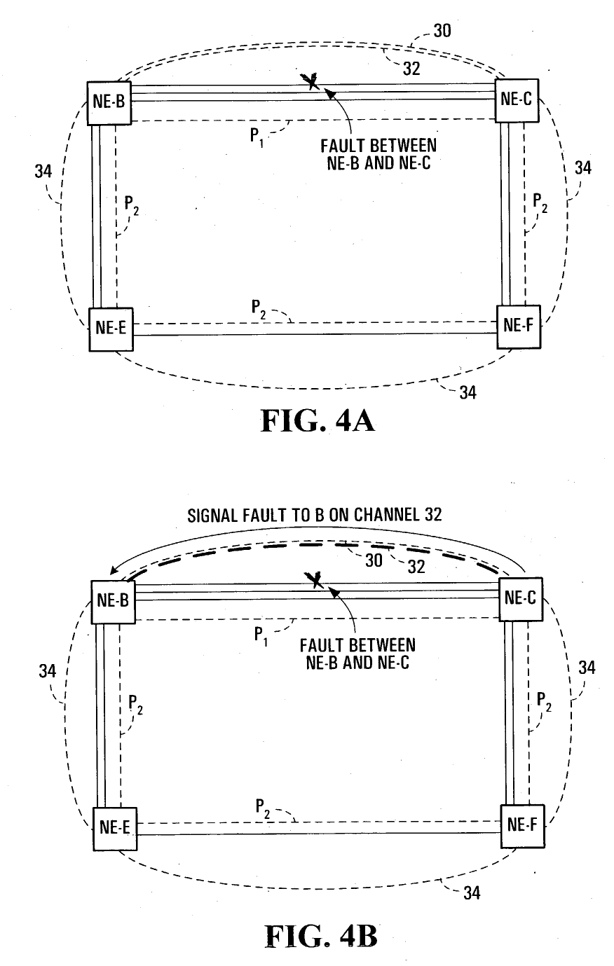

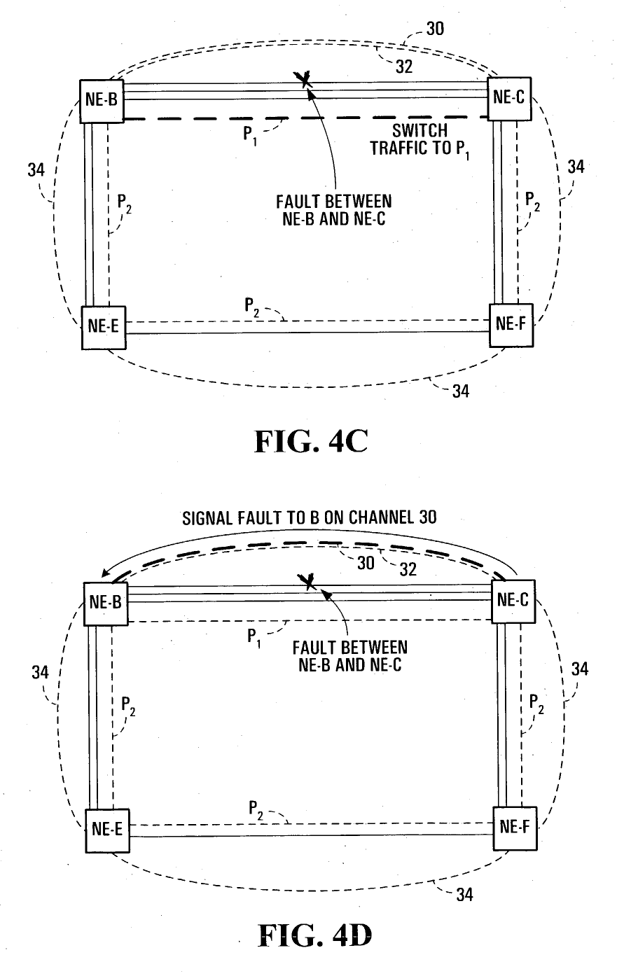

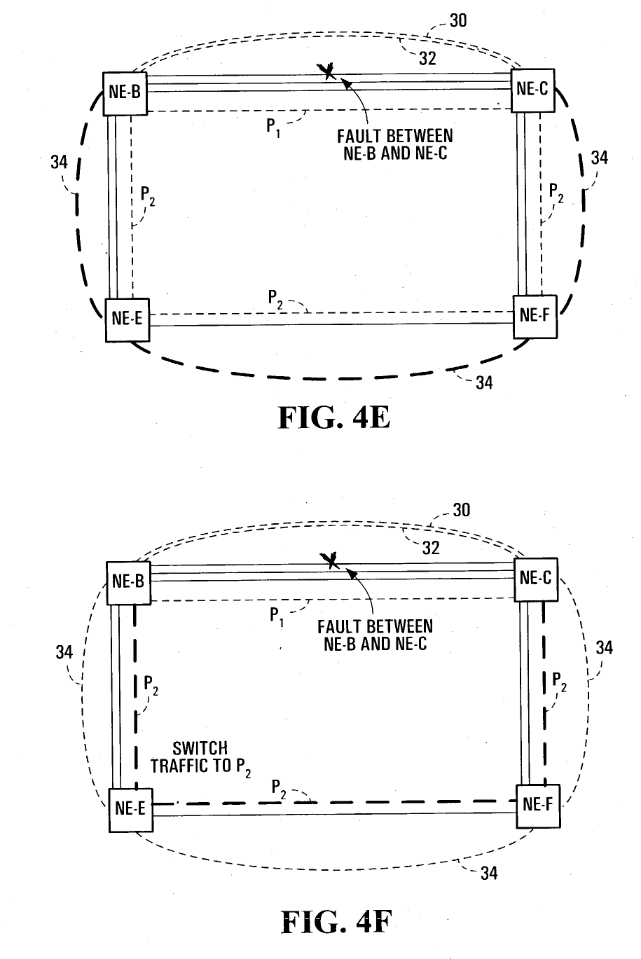

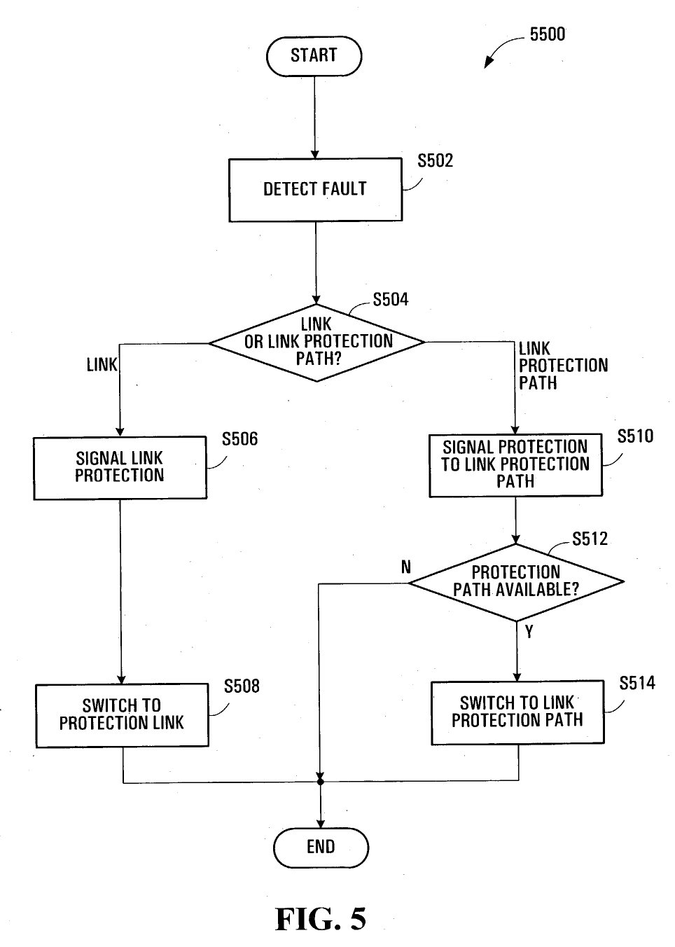

For a working link B-C of FIG. 1, this is schematically illustrated in FIGS. 4A-4C. Again, only those nodes 12 and links 16 and 18 of FIG. 3 of network 10 are illustrated in FIGS. 4A-4C. Corresponding steps performed at node C signalling the fault are illustrated in steps S500 depicted in FIG. 5. A fault, in the form of a signal failure, signal degrade, or the like, is detected at node C in a conventional manner. Upon detection of a fault in steps S502, at node C, node C initially assesses whether or not to switch to a single protection link 18 in step S504. It may do so, for example, by determining whether or not a designated protection link B-C already carries traffic. An appropriate switch to protection message is passed to immediately upstream node B depending on the decision reached in step S504. If traffic is to be switched to a single protection link 18, a fault indicator is transferred along link protection signalling channel 32 (FIG. 4B) to node B in step S506, thereby signalling the fault.

In response, node B providing 1:1 or 1:n protection switching places traffic destined for the working link B-C between nodes B and C on the protection link B-C as illustrated in FIG. 4C. Node C, in turn, may use the traffic received along the protection link B-C in place of traffic along the faulted working link B-C, in step S508. Traffic for all channels on the faulted working link B-C is thus restored along the link from node B to C. In the event, that 1+1 protection switching is used, node B may not need to be signalled of the fault. Instead node C may simply switch to receive traffic from the protection link B-C.

If protection switching at the link level for the fault is not to be used (e.g. it is not available) as determined in step S504, traffic may be switched to a provisioned link protection path P2 as illustrated in FIGS. 4D-4F. Specifically, a signal along the link protection path signalling channel 30 is dispatched to the node B, the head of the protected link B-C in step S510, as illustrated in FIG. 4D.

In response, node B dispatches a signalling message to node C over signalling channel 34 as illustrated in FIG. 4E. Node C, in turn may reply to node B in a reverse direction over this signalling channel to confirm existence of protection path P2. If the protection path P2 is indeed available, as determined in step S512, node B places the traffic carried by the faulted working link B-C, onto the link protection path P2, by placing the traffic onto the first link B-E of the link protection path P2 as illustrated in FIG. 4F. If path P2 is not available, as determined in step S512 node B simply need not switch working traffic to this path. As a result, the traffic may be lost.

Assuming P2 is available, established cross-connections at nodes E and F, in turn route traffic along protection links E-F and F-C, thereby ensuring traffic arrives at node C. Each node along the link protection path, in turn, maintains the status of protection links 18, and thereby tracks used protection links 18.

Once node C receives traffic originating with node B on link protection path P2, node C may switch to use this traffic in favour of the traffic carried on the faulted channel, in step S514. The mapping stored at node C may be used to choose traffic arriving from node F on the link protection path, in favour of traffic from the working link from node B.

To summarize, a two modes of protection switching may be signalled between node B and node C in the presence of a detected fault (FIG. 4A): in one mode a request to switch to protection is signalled along the link protection signalling channel 32 (FIG. 4B and step S506, FIG. 5); in another mode a request is sent along the link protection path signalling channel 30 (FIG. 4D and step S510, FIG. 5). As such, if node B is unable to switch traffic to a single protection link 18 between node C and node B, or if desired by an operator, traffic may be switched to an established link protection path P2 as illustrated in FIG. 4F, thereby providing an alternate path for traffic carried on working link 16 by way of one or more intermediate nodes (e.g. nodes E and F).

Conveniently, simple link and link protection path switching are nested. That is, in the event of failure along the working link 16 between node B and node C, the link protection switching between node B and node C may be assessed, in order to switch carriage of traffic from a working link 16 between node C and node D to a single protection link 18. If such a single protection link 18 is not available, as may be the case if the protection link 18 is already in use, as for example in the case of an existing fault along the link protected by 1:n protection switching, the fault may be otherwise signalled to the head of the working link 16. Thereafter, traffic along the working link 16 may be switched to an alternate link protection path, made up of several protection links 18.

Although in the illustrated embodiment the link protection path P2 has been established in advance of the fault along the working link 16, it should now be appreciated that such a link protection path could be established dynamically, after detection of a fault, as required. The head or tail end of the protected link 18 could, for example, dynamically establish a link protection path using a suitable signalling protocol. So in the example of FIGS. 4D-4F, software at node B could establish a link protection path using any suitable path establishment mechanism. For example, G.MPLS could be used to establish the required connections, to connect protection links B-E; E-F; and F-C. As will also be appreciated, dynamic establishment of a protection path requires time, that prevents switching of traffic to the link protection path, and introduces losses of traffic. Of course, such a link protection path might only be required in the event link protection for the faulted working link was not available. Conveniently, as a link protection path is not required in the case of all faults, delays associated with the establishment after the occurrence of a fault may be tolerable.

Conveniently, individual protection links 18 used along a link protection path (such as link protection path P2) may also be used to provide simple link protection switching. For example, protection link B-E may also function to provide simple link protection for a working link B-E. In this way, protection capacity between nodes may be shared: links may be used for link protection on the one hand; and as part of a link protection path, on the other. Of course, once protection link B-E has been used to provide protection for a failed working link 16, the protection link 18 cannot be used as part of link protection path P2. As such, a second layer of link protection may not be available for working link B-C. Conveniently, the reverse signalling message passed along channel 34 in step S512 (FIG. 5) could reflect that a link along the link protection path is otherwise used, thus preventing node B from switching to the link protection path. Alternatively, signalling channel 34 could be disconnected when link B-E is used to provide protection for a failed working link 16. As a consequence, signalling between nodes B and C by way of nodes E and F would no longer be possible. Of course, if a link protection path is established dynamically, node B could establish an alternate link protection path, in the presence of a failure on a working link to node C.

Possibly, each node 12 could provide a priority scheme for protection switching. In this way, if a higher priority request for an in-use protection link is received, the protection link 18 can be used for the subsequently received request for protection switching. For example, if a higher priority request to provide protection for working link B-E is received, in the presence of an established and in-use link protection path by way of link B-E, node B could simply drop the connection along the link protection path, in favour of providing protection for the faulted working link B-E.

As will now be appreciated by a person of ordinary skill, the invention may be embodied in many ways depending on the nature of the network 10 and traffic carrying nodes 12. Embodiments of the invention may, however, be better appreciated with reference to an example SONET network embodying the invention. Thus, for example, nodes 12 (FIG. 1) may be SONET cross-connects.

Link protection switching such as link protection switching between node B and node C may be effected in accordance with standard SONET protection switching mechanisms. ITU Recommendation G.783 and Bellcore GR-253 standard, for example, details conventional linear automatic protection switching (APS), providing for 1+1; 1:1 and 1:n protection switching.

Link protection path switching, on the other hand, may be effected as described below. Software governing the operation of nodes 12 may be suitably adapted to provide nested protection switching as detailed herein. Such software may be loaded at nodes 12 from a suitable computer readable medium 68.

A suitable mechanism for signalling faults to effect link and link protection path switching in SONET may best be understood with an understanding of the format of data transmitted in accordance with the SONET protocols as for example defined in ITU Recommendation G.707 of Bellcore GR-253. Specifically, SONET data is transmitted in frames. Each frame contains payload and overhead. According to the SONET standards, each link in a SONET network (for example links 16 in the network 10 of FIG. 1) can be designed to transport one or more SONET base signals.

A SONET base signal is referred to as a synchronous transport signal level 1 (STS-1) and is defined to operate at 51.84 megabits per seconds (Mbps). In conventional SONET systems, it is common to design optical links which can carry multiple STS-1 signals. Typically, STS-1 signals are multiplexed together and form higher level signals which operate at integer multiples of the basic STS-1 rate. For example, three multiplexed STS-1 signals can be multiplexed to form an STS-3 signal that operates at three times the base rate of 51.84 Mbps or at 155.520 Mbps. Similarly, forty-eight multiplexed STS-1 signals can form an STS-48 signal which operates at forty-eight times the base rate of 51.84 Mbps or at 2.488 gigabits per second (Gbps). Optical links which can carry n multiplexed STS-1 signals are typically referred to as OC-n links.

In the SONET network 10 of FIG. 1, links 16 may be OC-n links designed to meet different capacity demands. For the transmission of STS-N signals, such as an STS-192 signal (N=192), SONET defines a standard STS-N frame structure which includes an envelope portion for transporting payload data and various fields for overhead information. Nodes 12 cross-connect STS frames within the SONET stream. Each traffic bearing channel, as described above, is contained within one or more STS-1 signals.

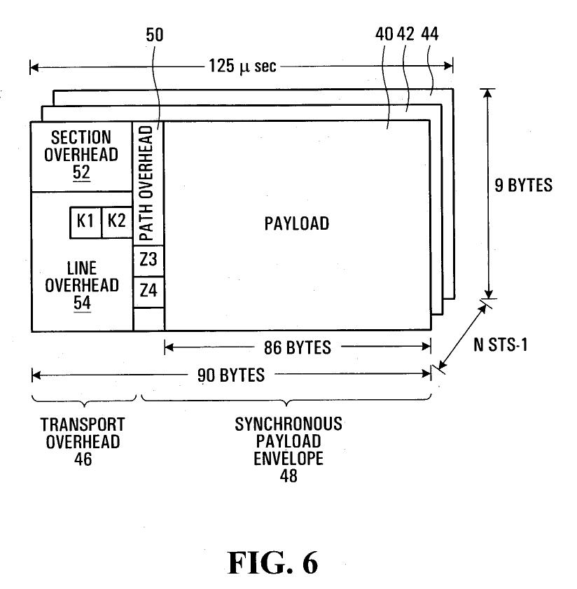

FIG. 6 illustrates an example of a standard STS-N frame as defined in SONET. The STS-N frame shown in FIG. 6 includes N STS-1 frames 40, 42, 44 (only three shown) which, in SONET, are respectively numbered 1 to N. The number N of STS-1 frames 40, 42, 44 contained in the STS-N frame normally corresponds to the number of STS-1 signals carried in the STS-N signal. Thus, for an OC-192 link, the STS-N frame would consist of 192 STS-1 frames with each frame corresponding to one of the multiplexed 192 STS-1 signals.

In the STS-N frame of FIG. 6, the STS-1 frames 40, 42, 44 are all identically structured in accordance with a standard frame format defined in SONET. Considering in particular the STS-1 frame 40, the STS-1 frame format defined in SONET is a specific sequence of 810 bytes or 6480 bits arranged in a 90-column by 9-row structure where each column contains 9 bytes and each row contains 90 bytes. According to SONET, the STS-1 frame 40 has a frame length of 125 psec. With a 125 psec frame length, 8000 STS-1 frames such as the STS-1 frame 40 can be transmitted each second. Considering that each STS-1 frame contains 6480 bits, the rate at which an STS-1 signal can be transmitted is given by:

STS-1 rate=6480 bits/frame*8000 frames/second;

=51.84 Mbps

which, as noted above, is the base rate in SONET.

Considering the STS-1 frame 40 in more detail, the first three columns (columns 1 through 3) of the frame 40 are used for transport overhead 46 while the remaining columns (columns 4 through 90) define a synchronous payload envelope (SPE) 48. SPE 48 consists of 783 bytes and can be depicted as 87-columns by 9-rows. The SPE 48 is predominantly used to carry payload data but the first column consisting of 9 bytes is allocated for a path layer overhead 50 (hereinafter referred to as the path overhead).

The transport overhead 46 is located in the first three columns of the STS-1 frame, these columns containing a total of 27 bytes. Of these, 9 bytes are allocated for section layer overhead 52 (hereinafter referred to as the section overhead) and 18 bytes are provisioned for line layer overhead 54 (hereinafter referred to as the line overhead). The section overhead 52 is located in rows 1 to 3 of the transport overhead 46 and is typically used to support SONET section control functions including signal performance monitoring, administration, maintenance and provisioning between section-terminating equipment. The line overhead 54 is located in rows 4 to 9 of the transport overhead 46 and is typically used to support SONET line control functions such as signal multiplexing, protection switching and maintenance between line-terminating equipment.

In one embodiment, the conventional SONET linear protection switching mechanism protecting the link between node B and node C and supported at these nodes need not be modified to allow nested protection switching, exemplary of an embodiment of the present invention. For SONET nodes, faults between node B and node C, and the corresponding request for protection switching at node B and node C may be performed as detailed in ITU Recommendation G.783. To effect link protection switching as detailed herein, signalling channel 32 may be embodied as the APS signalling channel using bytes K1 and K2 of the line overhead 54.

As will be appreciated by a person of ordinary skill, this APS signalling channel may be contained in the SONET overhead of the protection link or in the overhead associated with a remaining working link. It is used to signal faults, and effects linear protection switching along the protected link.

Specifically, as detailed in these recommendations, in the event of a fault, the fault may be signalled from the tail end to the head end in an APS channel carried in association with the protection link 18 between node B and node C. K1 and K2 bytes are carried in the line overhead 54 associated with the protection link 18. K1 and K2 may signal the identity of the faulted link.

At the head end of the link, traffic on the link identified in the K1 and K2 bytes is placed onto the established protection link 18. At the tail of the link, traffic previously transported on the failed working link 16 may be received on the protection link 18.

Although an APS channel is provided for in the overhead associated with all working and protection links 16 and 18, the APS channel associated with the protection link 18 or another working link 16 is used as failure of the working link 16 often causes failure of the APS channel carried in the overhead associated with the working link 16.

Now, exemplary of an embodiment of the present invention, if the protection link 18 between adjacent nodes 12 is not available, node C may signal the fault to the head end of the working link 16 along another signalling channel such as path signalling channel 30.

The faulted link may, for example, be explicitly identified using the signalling channel 30. As noted, a mapping of the working link 16 to an alternate link protection path is stored at the head end of the link 16. Thus, once the identity of the faulted link is recognized at node B, traffic destined for the working link 16 may be cross connected to the associated link protection path at the head end of the link.

Exemplary of an embodiment of the present invention, signalling channels contained in the line overhead (e.g. K1/K2 bytes) of the SONET protocol associated with one or more working links 16 between the adjacent nodes may be used to signal a switch from a working link 16 to the link protection path, and thus operate as path signalling channels 30.

Signalling channel 34 could similarly be formed using line overhead between nodes along path P2. For example, signalling channel 34 could be formed using K1/K2 bytes of the protection links B-E; E-F; F-C. Nodes E and F may cross-connect signalling channels on individual links to ensure continuity of the signalling channel 34 from node B to C.

Alternatively, as each SONET frame carries K1 and K2 bytes, 8000 K1 and K2 bytes are transported between adjacent nodes for each STS, per second. These 8000 K1 and K2 bytes may be time-division multiplexed to transport both link protection path signalling channel 30 and link protection signalling channel 32. Thus, both link and link protection path switching could be signalled along the path using K1 and K2 bytes associated with the working or protection links between the nodes. At the head of a link, relevant signalling information could be de-multiplexed.

Alternatively, signalling information could be carried along an alternate signalling network. For example, a G.MPLS network could be used to signal link and/or link protection path signalling information. For example, link protection signalling could be carried in K1 and K2 bytes as specified in ITU Recommendation G.783. In the event, link protection switching is not available, the fault could be signalled to the source node using an MPLS signalling network. Alternatively, both link and link protection path signalling could be carried by a signalling network.

The degree of modification to software embodying conventional protocols will vary depending on the nature of the signalling protocol, and the network protocol supported at each node. It is expected that such modification is within the skill of a person of ordinary skill in the art.

All documents referred to herein are hereby incorporated by reference herein, for all purposes.

Of course, the above described embodiments, are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. In a communications network, comprising a plurality of network nodes interconnected in a mesh and a working link extending between first and second adjacent ones of said network nodes, a method of, signalling a fault on said working link, said method comprising:
determining if said working link is to be protected by way of a single protection link between said first and second nodes, or by way of a link protection path extending from said first node to said second node by way of an intermediate node;
signalling said first node to initiate switching of traffic from said working link to said single protection link or to said link protection path, in dependence on said determining.

2. The method of claim 1, wherein said determining comprises determining if said single protection link is available to carry said traffic from said working link.

3. The method of claim 1, further comprising establishing said link protection path from said first node to said second node by way of said intermediate node.

4. The method of claim 3, wherein said link protection path is established in response to receiving an indication of said fault at said first node.

5. The method of claim 4, wherein said link protection path is established by said first node using a path establishment protocol.

6. The method of claim 1, wherein said nodes transport data in accordance with the SONET protocol along said working link, and wherein said fault is signalled to said first node using SONET line overhead.

7. The method of claim 6, wherein a portion of said line overhead is multiplexed to carry two signalling channels each to signal said fault to said first node.

8. The method of claim 1, wherein said fault is signalled to said first node using a G.MPLS signalling network.

9. A communications network comprising:
a. a plurality of communications nodes communicatively interconnected in a mesh by links, each of said links connecting two adjacent nodes;
b. a working link provisioned to carry traffic, said working link extending between first and second nodes;
c. a protection link extending alongside said working link, provisioned to carry said traffic in the event of a fault along said working link;
d. a link protection path comprising a plurality of cross-connected protection links, said link protection path extending between said first and second nodes and through at least one intermediate node to carry said traffic between said first and second nodes in the event of a fault along said working link;
e. at least one signalling channel to signal a fault on said working link to said first node, thereby allowing said first node to switch said traffic on said working link to said protection link or said link protection path.

10. The network of claim 9, wherein each of said plurality of communications nodes comprises a SONET cross-connect.

11. The network of claim 10, wherein one of said at least one signalling channels is contained in SONET overhead on said working link between said first and second nodes.

12. A node in a communications network comprising:
a switch fabric for cross-connecting input links to output channels;
a processor in communication with said switch fabric, and operable to
establish cross-connects in said switch fabric;
detect a fault on a working link switched by said switch fabric;
determine a mode of signalling of said fault;
signal said fault to an immediately upstream node, to effect protection switching of traffic on said working link to one of a protection link connecting said node to said immediately upstream node, or a link protection path connecting said node to said immediately upstream node by way of an intermediate node.

13. The node of claim 12, wherein said node is a SONET compliant node and said processor is operable to signal said immediately upstream node to switch to said protection link by dispatching a signal in SONET overhead.

14. The node of claim 13, wherein said processor is operable to dispatch said signal in SONET line overhead on said protection link.

15. The node of claim 12, wherein said node is a SONET compliant node and said processor is operable to signal said immediately upstream node to switch to said link protection path by dispatching a signal in SONET line overhead of a working link between said node and said immediately upstream node.

16. In a communications network, comprising a plurality of network nodes interconnected in a mesh, a method of providing nested protection switching for a working link between an adjacent first and second communications node on said network, said method comprising:
provisioning a protection link, extending between said first and second nodes;
provisioning a link protection path, extending from said first node to said second node by way of an intermediate node;
switching traffic carried on said working link to said protection link or said link protection path, in dependence on receiving an indicator of a fault on said working link.

17. The method of claim 16, wherein said link protection path is established using a path establishment protocol, after a fault on said working link has been detected.

18. The method of claim 16, wherein said network comprises SONET compliant communications nodes, and further comprising receiving a signalling message as part of SONET overhead on said protection link.

19. The method of claim 16, wherein said network comprises SONET compliant communications nodes, and further comprising receiving a signalling message as part of SONET overhead on another working link extending between said first and second nodes.

20. A computer readable medium storing processor executable instructions that when loaded at a network interconnected communications node, adapt said communications node to perform the method of claim 1.

21. A computer readable medium storing processor executable instructions that when loaded at a network interconnected communications node, adapt said communications node to perform the method of claim 16.

22. A node in a mesh connected communications network comprising:
means for establishing cross-connects between links at said node;
means for detecting a fault on a working link connected to said means for establishing cross-connects;
means for signalling said fault to an immediately upstream node, to effect protection switching of traffic on said working link to a protection link connecting said node to said immediately upstream node;
means for signalling said fault to said immediately upstream node, to effect protection switching of traffic on said working link to said link protection path connecting said node to said immediately upstream node by way of an intermediate node.
